(19) United States
(12) Patent Application Publication
(10) Pub. No.: US 2014/0305894 A1
(43) Pub. Date: Oct. 16, 2014

(54) ROLLER TRACK ASSEMBLY

(71) Applicant: L&P PROPERTY MANAGEMENT COMPANY, South Gate, CA (US)

(72) Inventor: Steven C. Thompson, Elkhart, IN (US)

(21) Appl. No.: 13/860,766

(22) Filed: Apr. 11, 2013

(51) Int. Cl. B65G 1/02; B65G 13/11; A47F 5/00

(52) U.S. Cl. CPC B65G 1/023; A47F 5/0093; B65G 13/11
USPC 211/162; 193/37; 29/428

(57) ABSTRACT

A roller track assembly for use with a product display includes a roller having opposing support portions. An inner casing includes a base and opposing side walls extending orthogonally from the base. One of the opposing side walls forms a notch configured to receive one of the opposing support portions of the roller and defining a first interior surface. An outer casing has first and second walls in a parallel relationship with the opposing side walls of the inner casing. The first wall of the outer casing forms a notch configured to receive the one of the opposing support portions of the roller and defining a second interior surface. The outer casing is positioned with respect to the inner casing such that the one of the opposing support portions is cooperatively retained in place by a portion of the first interior surface and a portion of the second interior surface.

### BACKGROUND

The present invention relates to product displays, and more particularly to a roller track assembly for use with an adjustable product display.

Different configurations and designs of product displays are available. Some product displays are specifically configured or sized for particular products, while others are adjustable to accommodate a wide variety of products. Some product displays incorporate product support surfaces that are inclined relative to the ground to facilitate “fronting” of the products in the product display. Some product displays incorporating inclined product support surfaces include one or more roller track assemblies each having a plurality of rollers to further facilitate product fronting in the product display.

### SUMMARY

In one embodiment a roller track assembly for use with a product display includes a roller having opposing support portions. An inner casing includes a base and opposing side walls extending orthogonally from the base. One of the opposing side walls forms a notch configured to receive one of the opposing support portions of the roller. The notch of the one of the side walls defines a first interior surface. An outer casing has first and second walls in a parallel relationship with the opposing side walls of the inner casing. The first wall of the outer casing forms a notch configured to receive the one of the opposing support portions of the roller. The notch of the first wall of the outer casing defines a second interior surface. The outer casing is positioned with respect to the inner casing such that the one of the opposing support portions is cooperatively retained in place by a portion of the first interior surface and a portion of the second interior surface.

In one embodiment a method of assembling a roller assembly for use with a product display includes receiving end portions of a roller within opposing notches formed in opposing side walls extending orthogonally from a base of an inner casing, wherein the notches each define a first interior surface. The method also includes positioning the inner casing within first and second walls of an outer casing, the first and second walls oriented in parallel to the opposing side walls. The method further includes receiving the end portions of the roller within opposing notches formed in the first and second walls, wherein the notches in the first and second walls of the outer casing each define a second interior surface. The method additionally includes positioning the outer casing with respect to the inner casing such that the end portions are cooperatively retained in place by a portion of the first interior surface and a portion of the second interior surface.

In one embodiment a product display includes a plurality of upright members, a frame coupled to the plurality of upright members, and a plurality of roller track assemblies coupled to the frame. Each roller track assembly includes a roller having opposing support portions. An inner casing includes a base and opposing side walls extending orthogonally from the base. One of the opposing side walls forms a notch configured to receive one of the opposing support portions of the roller. The notch of the one of the side walls defines a first interior surface. An outer casing has first and second walls in a parallel relationship with the opposing side walls of the inner casing. The first wall of the outer casing forms a notch configured to receive the one of the opposing support portions of the roller. The notch of the first wall of the outer casing defines a second interior surface. The outer casing is positioned with respect to the inner casing such that the one of the opposing support portions is cooperatively retained in place by a portion of the first interior surface and a portion of the second interior surface.

Other aspects of the invention will become apparent by consideration of the following detailed description and accompanying drawings.

### BRIEF DESCRIPTION OF THE DRAWINGS

FIG. 1 is a perspective view of a product display of the present invention.

FIG. 2 is a top perspective view of a roller assembly of the product display of FIG. 1.

FIG. 3 is an exploded view of the roller assembly of FIG. 2.

FIG. 4 is a bottom perspective view of the roller assembly of FIG. 2.

FIG. 5 is an exploded side view of the roller assembly of FIG. 2.

FIG. 6 is a side view of the roller assembly of FIG. 2.

FIG. 7 is an enlarged partial cross-sectional view of the product display of FIG. 1 through line 7-7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

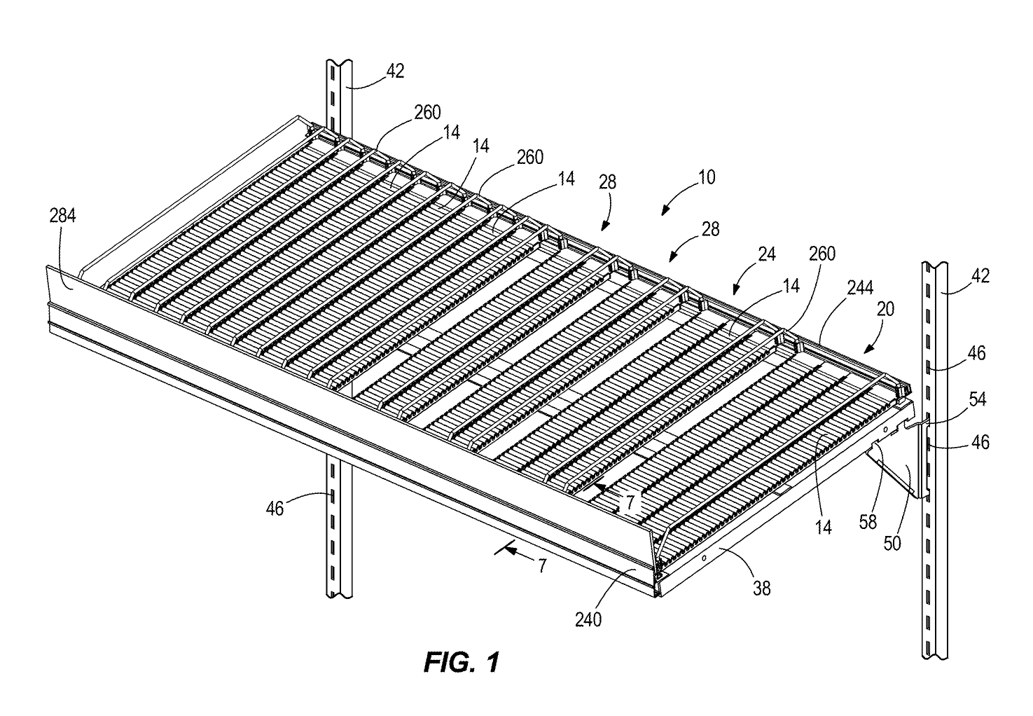

A first embodiment of a product display 10 is shown in FIG. 1. The product display 10 may be configured or adapted to support different width products (not shown) using one or more modular product supports or roller track assemblies 14. In the illustrated construction of the product display 10, a first grouping of four roller track assemblies 14 creates a “four-wide” product support 20 for a product of commensurate width; a second grouping of three roller track assemblies 14 creates a “three-wide” product support 24; and third and fourth groupings of two roller track assemblies 14 creates two “two-wide” product supports 28. The remaining roller track assemblies 14, adjacently positioned as illustrated, each support a product having a width not greater than the width of a single assembly 14. The product supports 20, 24, 28, and the individual roller assemblies 14 of FIG. 1, may or may not be adjacently interconnected. Alternatively, the product display 10 may be configured in any of a number of different ways to support different width products thereon.

With continued reference to FIG. 1, the product display 10 is oriented at an incline with respect to a support surface (e.g., the ground) to facilitate gravity-feeding or “fronting” of the products supported on the product display 10. To facilitate fronting of the products, each of the roller track assemblies 14 includes a plurality of rollers (discussed in more detail below) upon which the products slide to reduce the friction between the products and the product display 10. As such, when a customer removes a forward-most product from a particular grouping or roller track assembly, the weight of each of the remaining products positioned behind the forward-most product causes the remaining products to slide forward such that the next product in line assumes the position of the forward-most product.

The product display 10 is supported by a frame 38 which, in turn, is supported by one or more uprights 42 of a shelving system. The frame 38 is configured having a plurality of interconnected frame members (e.g., stamped sheet metal frame members). Alternatively, the frame 38 may be constructed in any of a number of different ways. As shown in FIG. 1, each of the uprights 42 includes a plurality of slots 46 spaced along the length of the upright 42 at equal increments. A bracket 50 is matched with each upright 42 to interconnect opposite sides of the frame 38 with respective parallel uprights 42. Each of the brackets 50 includes a first pair of tabs or hooks 54 that are received in respective slots 46 in the upright 42 in a conventional manner to secure the bracket 50 to the upright 42. Each of the brackets 50 further includes a second pair of tabs or hooks 58 that are received in corresponding slots (not shown) in the frame 38 in a conventional manner to secure the frame 38 to the bracket 50. The desired incline of the product display 10 is provided by the interconnection between the brackets 50 and the frame 38. Alternatively, other structure may be utilized to provide the desired incline of the product display 10 with respect to ground. Other types of brackets and frame combinations known to those of skill in the art can alternatively be used to support the product display 10.

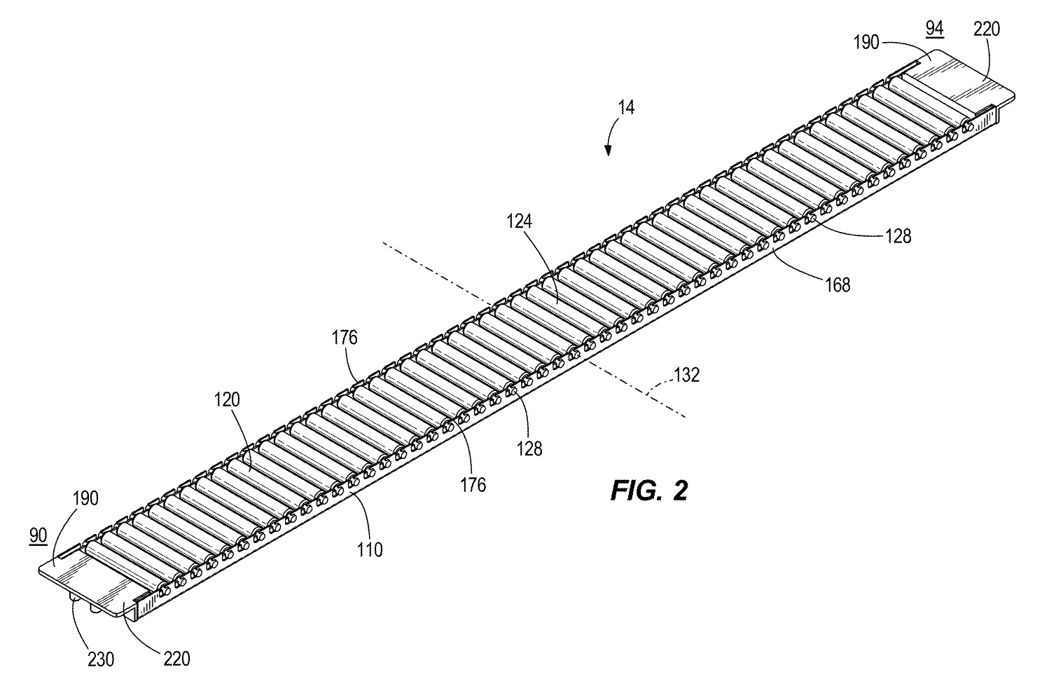

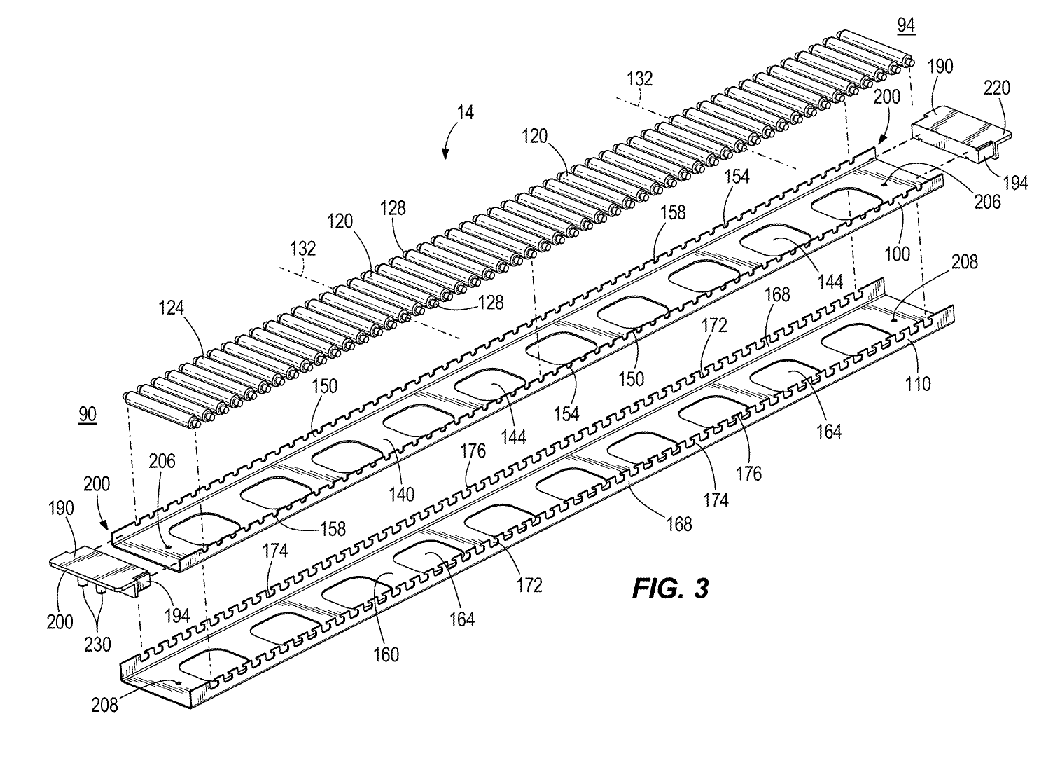

Referring to FIGS. 2 and 3, the roller track assembly 14 is referenced with respect to a front side 90 and a rear side 94. The assembly 14 includes a first inner member or casing 100, a second outer member or casing 110, and a plurality of rollers 120. A lengthwise direction is defined from the front side 90 to the rear side 94.

Each roller 120 of the plurality of rollers 120 comprises a contact surface portion 124 and first and second opposing support portions 128 in the form of pins or hubs extending from the roller body. The contact surface portion 124 presents a rolling surface to the product in contact therewith. The rollers 120 are generally cylindrical and rotatable about respective axes 132 oriented transversely to the length of the roller track assembly 14 and concentric with the support portions 128. As such, cooperative rotation of the cylindrical rollers 120 about their respective axes 132 imparts movement to products situated on the contact surface portions 124 in a direction along the length of the product support 14 from the rear side 94 to the front side 90. The rollers 120 are preferably formed from plastic, e.g., ABS plastic, from a molding operation, and the contact surface portion 124 and support portions 128 of each roller 120 are preferably molded as a single integral component. In some constructions, the rollers 120 can be formed from metal. In yet other constructions, the roller bodies 120 may be configured as spherical rollers having multiple degrees of freedom.

The inner casing 100 includes a bottom plate 140 or base through which are formed a plurality of apertures 144. Opposing walls or sides 150 generally orthogonal to the bottom plate 140 each include equally or particularly spaced opposing notches 154 spanning from approximate the front side 90 to approximate the rear side 94. Each notch 154 is sized to receive and support a support portion 128 of a respective roller 120 and defines an inner or interior surface 158 for supporting an individual roller 120. The sides 150 can be integrally formed with the bottom plate 140, or alternatively separately formed and coupled to the bottom plate 140 by a method of attachment known to those of skill in the art.

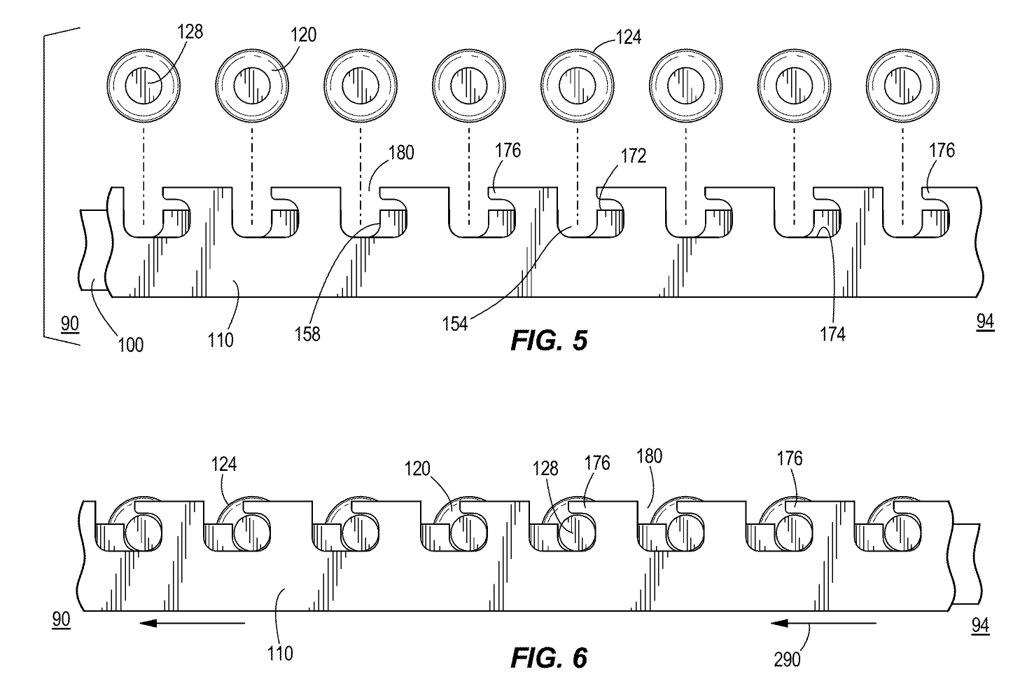

The outer casing 110 includes a bottom plate 160 through which are formed a plurality of apertures 164 configured to match the plurality of apertures 144 of the inner casing 100 when the roller track assembly 14 is fully assembled. The outer casing 100 includes opposing generally orthogonal walls or sides 168 laterally spaced to receive the sides 150 of the inner casing 100 therebetween. In some constructions, the fit between the inner and outer casings 100, 110 is an interference fit or approximates an interference fit. Each side 168 extends orthogonally farther away from the bottom plate 160 than does each side 150 from the bottom plate 140 such that the inner casing 100 is wholly contained within the outer casing 110 upon assembly, as will be detailed below. The opposing sides 168 include equally or particularly spaced opposing notches 172 that are each larger than the notches 154, i.e., the notches 172 of the outer casing 110 are longer in the lengthwise direction than the notches 154 of the inner casing 100, the purpose of which will be further explained. Referring also to FIGS. 5 and 6, the notch 172 geometry is further defined by an inner or interior surface 174 for supporting a roller 120 and an extension portion 176 projecting frontwardly to form an opening 180. In other constructions, the extension portion 176 projects rearwardly to form the opening 180.

Each of the inner casing 110 and outer casing 110 are preferably formed from metal.

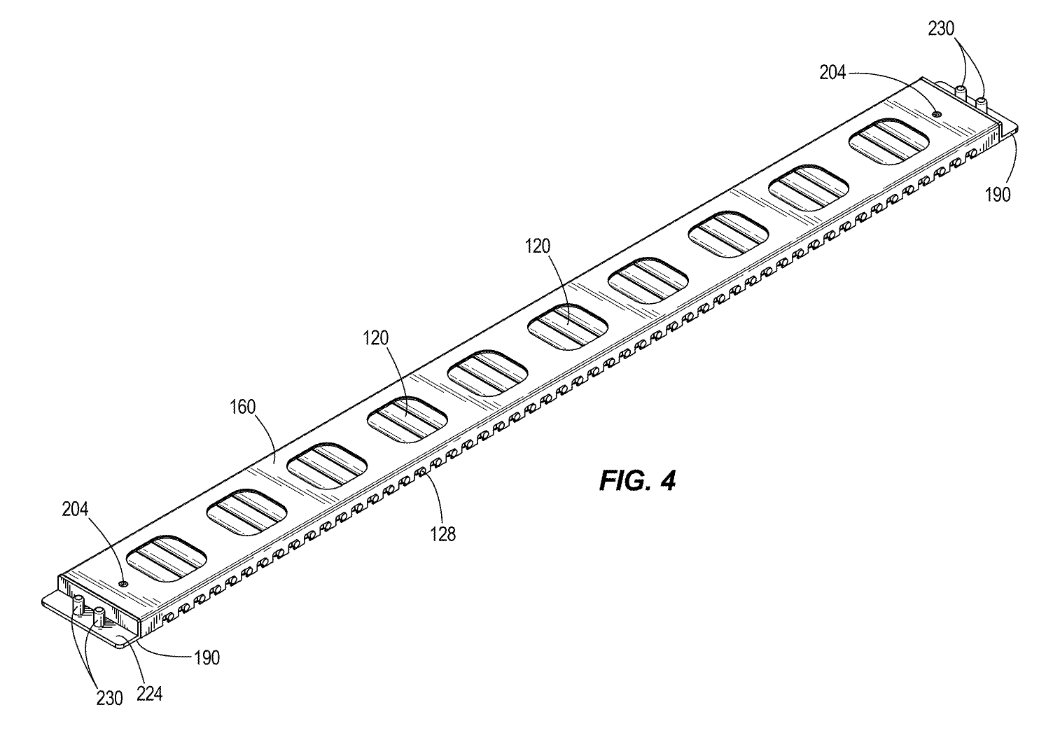

Referring again to FIGS. 2-4, first and second end mounting pieces 190 are configured for coupling to the inner casing 100. Each of the mounting pieces 190 includes an insertion portion 194 having a generally rectangular cross-sectional shape that corresponds with an end portion 200 of the inner casing 100. The insertion portion 194 of each of the mounting pieces 190 is sized to provide an interference fit with the inner casing 100 when the insertion portion 194 is received within the end portion 200 to secure the inner casing 100 to the mounting pieces 190. Additionally or alternatively, the inner and outer casings 100, 110 may be secured to the mounting pieces 190 in any of a number of different ways (e.g., using fasteners, adhesives, etc.), such as with a screw 204 passing through screw holes 206, 208 in the respective casings 100, 110.

With continued reference to FIGS. 2-4, each of the mounting pieces 190 also includes a connecting portion 220 adjacent the insertion portion 194. The connecting portion 220 includes a face 224 from which extend first and second pegs 230 configured to mate with corresponding receptacles integrally formed into respective front and rear rails attached to frame 38, to be further described. In the illustrated embodiment, the first and second pegs 230 are molded or otherwise inserted into the face 224 of the connecting portion 220. Alternatively, the mounting pieces 190 may be differently configured for coupling to rails, for example, with screw bosses. In some constructions, differently configured mounting pieces 190 include locking members (not shown) to facilitate inter-engagement or interconnection of adjacent mounting pieces 190. The exact configuration of each connecting portion 220 is dependent on the shelving application for which the roller track assemblies 14 are used.

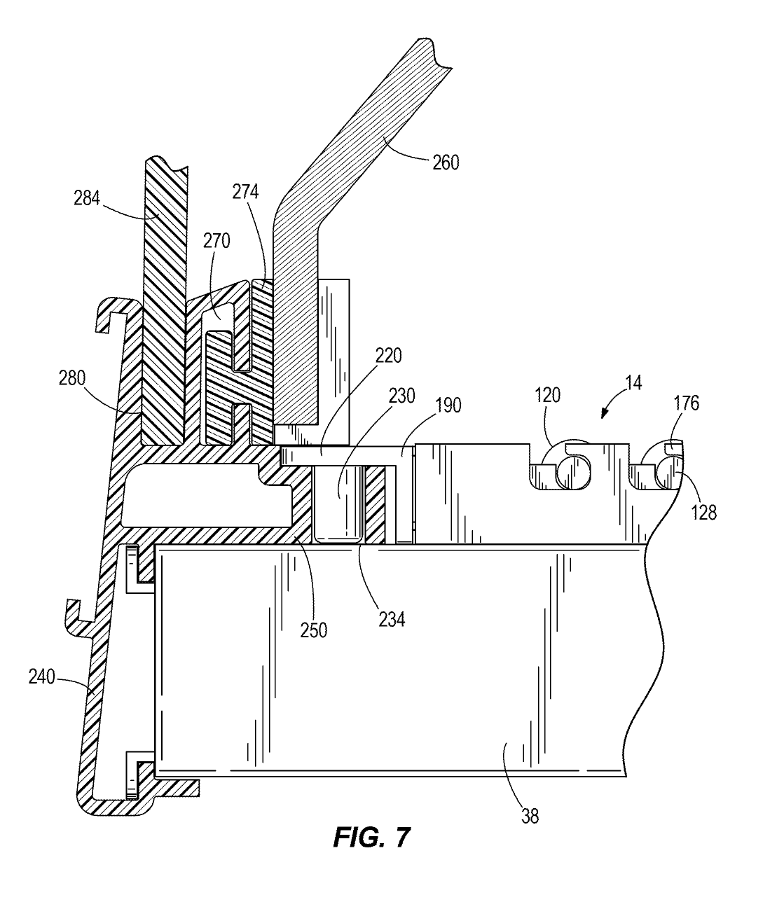

With continued reference to FIG. 1, a front rail 240 is elongated transversely across the display 10 and is in the direct line of sight of individuals viewing products situated on the display 10. A rear rail 244 positioned at the rear side of the display 10 includes features identical to those of the front rail 240 and thus only the front rail 240 will be further described herein. With reference to FIG. 7, the front rail 240 includes a receiving portion 250 extending in a direction substantially parallel with the length of the front rail 240 to which one or more mounting pieces 190 of each roller track assembly 14 are coupled. Specifically, the receiving portion 250 includes a plurality of receptacles 234 spaced along the length of the front rail 240 to receive the pegs 230 of the connecting portion 220. As will be understood, the receptacles 234 are spaced along the length of the receiving portion 250 such that a particular roller track assembly 14 can be positioned at desired locations along the length of the front rail 240. In some constructions, the spacing of the pegs 230 and receptacles 234 can be varied to permit incremental positioning of the roller track assembly 14. In other constructions, the receiving portion 250 is differently configured to couple a mounting piece connecting portion 220 of alternative geometry.

Referring again to FIG. 1, the product display 10 also includes a plurality of product dividers 260 coupled to and positioned between the respective front and rear rails 240, 244 and utilized to define and separate the adjacent rows of products on individual or grouped roller track assemblies 14, 20, 24, 28. As shown in FIG. 1, a product divider 260 is positioned on either side of the product supports 20, 24, and 28 and on either side of the rows of products having only a single roller track assembly 14. The product dividers 260 may be omitted in an alternative configuration of the product display 10. Referring to FIG. 7, the front rail 240 includes a channel 270 to receive a front base 274 of the product divider 260. The channel 270 extends in a direction substantially parallel with and along the entire length of the rail 240. As a result, the product divider(s) 260 may be positioned at any incremental position along the length of the rail 240. The rail 244 is similarly configured to facilitate the aforementioned positioning of the divider(s) 260.

With continued reference to FIG. 7, the front rail 240 includes an upwardly-facing channel 280 extending in a direction substantially parallel with and along the entire length of the front rail 240 in which a retaining wall 284 is received (see also FIG. 1). When coupled to the front rail 240, the retaining wall 284 provides a front stop to the forward-most products in each row or grouping of products. An interference fit between the retaining wall 284 and the channel 280 is sufficient to secure the retaining wall 284 to the front rail 240. Alternatively, the retaining wall 284 may be secured to the front rail 240 in any of a number of different ways (e.g., using fasteners, adhesives, etc.). As yet another alternative, the retaining wall 284 and the front rail 240 may be integrally formed as a single piece.

The mounting pieces 190, rails 240, 244, dividers 260, and retaining wall 284 can additionally be configured in any form as described and illustrated in U.S. Patent Application Publication No. 2010/0206829, the contents of which are herein incorporated by reference.

With reference to FIG. 1, the product display 10 may be assembled and customized according to the specific sizes of the products that are supported on the product display 10. Particularly, individual roller track assemblies 14 may be employed to support products having a width substantially the same as or less than that of the individual roller track assemblies 14, while two or more assemblies 14 may be assembled in an adjacent relationship and, if locking members are present, interconnected as modules to create a larger, unitized product support (e.g., similar to product supports 20, 24, 28) capable of supporting products having a width greater than the width of an individual roller track assembly 14.

Referring to FIGS. 2, 3, 5, and 6, to assemble an individual roller track assembly 14, the inner casing 100 is first positioned within the outer casing 110 such that each notch 172 in outer casing 110 is offset in the rearward direction with respect to an adjacent notch 154 of the inner casing 100 (see FIG. 5). This positioning permits the reception of the first and second opposed support portions 128 of the rollers 120 through the opening 180 into both notches 154, 172. Alternatively, the rollers 120 are first placed within the notches 154 of the inner casing 100, after which the partially assembled rollers 120 and inner casing 100 are placed within the outer casing 110. Regardless of how the inner casing 100 is placed within outer casing 110, once so positioned, the outer casing 110 is moved in the frontward direction, as shown by arrow 290 of FIG. 6. This translational movement of the outer casing 110 with respect to the inner casing 100 disposes the extension portions 176 to at least partially obstruct the first and second opposed support portions 128 of each roller 120 such that the portions 128 are retained in place between the inner surfaces 158, 174 of the notches 154, 172 and the extension portions 176 as shown in FIG. 6. That is, when outer casing 110 is moved to the forward position shown in FIG. 6, the extensions 176 capture roller support portions 128 in notches 154, 172 so that the rollers 120 are rotatably retained in place between the opposed sides 150, 168 of the inner and outer casings 100, 110. In some constructions, the inner casing 100 is tack welded to the outer casing 110 after the outer casing 110 is moved to permanently secure the rollers 120 to the casings 100, 110. The mounting pieces 190 are coupled to the end portions 200 of the inner casing 100 and optionally secured thereto with the previously described fastener(s) (e.g., one or more screws 204). Individual roller track assemblies 14 are then coupled to the rails 240, 244. In the illustrated embodiment, the pegs 230 are cooperatively mated with the receptacles 234 formed in the receiving portion 250. Once coupled, the mating between the pegs 230 and the receptacles 234 hinders translational motion frontward, rearward, or laterally of the assemblies 14 with respect to the rails 240, 244.

Each of the product dividers 260 can be slidably received between, adjacent to, or on top of, the front and rear rails 240, 244 and then moved or adjusted to a final position along the length of the rails 240, 244. As shown in FIG. 1, a product divider 260 is positioned adjacent each longitudinal edge of the nine individual roller track assemblies 14 and each of the product supports 20, 24, 28 to create a boundary on either side of the individual assemblies or product supports 14, 20, 24, 28. The product dividers 260 are separately adjusted to allow for specific placement of products along the length of the rails 240, 244.

The roller track assembly or assemblies 14, now coupled with the rails 240, 244, are affixed to the frame 38. In some constructions, the rails 240, 244 are first affixed to the frame 38 and thereafter the roller track assemblies 14 are coupled to the respective rails 240, 244.

Various features of the invention are set forth in the following claims.

What is claimed is:

1. A roller track assembly for use with a product display, the roller track assembly comprising:
a roller having opposing support portions;
an inner casing including a base and opposing side walls extending orthogonally from the base, one of the opposing side walls forming a notch configured to receive one of the opposing support portions of the roller, the notch of the one of the side walls defining a first interior surface; and
an outer casing having first and second walls in a parallel relationship with the opposing side walls of the inner casing, the first wall of the outer casing forming a notch configured to receive the one of the opposing support portions of the roller, the notch of the first wall of the outer casing defining a second interior surface,
wherein the outer casing is positioned with respect to the inner casing such that the one of the opposing support portions is cooperatively retained in place by a portion of the first interior surface and a portion of the second interior surface.

2. The roller track assembly of claim 1, wherein the first wall of the outer casing includes a projection extending parallel thereto, the projection partially forming an opening and further defining the second interior surface.

3. The roller track assembly of claim 2, wherein the projection is positioned to restrict movement of the one of the opposing support portions away from the inner casing.

4. The roller track assembly of claim 1, wherein the outer casing is affixed to the inner casing.

5. The roller track assembly of claim 1, wherein the outer casing is slidable with respect to the inner casing.

6. The roller track assembly of claim 1, wherein the opposing side walls of the inner casing are entirely contained within the first and second walls of the outer casing in a direction orthogonal from the base.

7. The roller track assembly of claim 1, wherein the inner casing is configured for an interference fit with the outer casing.

8. A method of assembling a roller assembly for use with a product display, the method comprising:
receiving end portions of a roller within opposing notches formed in opposing side walls extending orthogonally from a base of an inner casing, wherein the notches each define a first interior surface;
positioning the inner casing within first and second walls of an outer casing, the first and second walls oriented in parallel to the opposing side walls;
receiving the end portions of the roller within opposing notches formed in the first and second walls, wherein the notches in the first and second walls of the outer casing each define a second interior surface; and
positioning the outer casing with respect to the inner casing such that the end portions are cooperatively retained in place by a portion of the first interior surface and a portion of the second interior surface.

9. The method of claim 8, wherein the base extends in a lengthwise direction, and where positioning the outer casing with respect to the inner casing comprises translating the outer casing in the lengthwise direction.

10. The method of claim 9, wherein the first and second walls of the outer casing each include a projection extending in the lengthwise direction and further defining the second interior surface, and where translating the outer casing in the lengthwise direction positions the projection to restrict movement of the roller away from the inner casing.

11. The method of claim 8, further including affixing the outer casing to the inner casing.

12. The method of claim 8, wherein positioning the inner casing within the first and second walls of the outer casing comprises positioning the inner casing entirely within the first and second walls in a direction orthogonal from the base.

13. A product display comprising:
a plurality of upright members;
a frame coupled to the plurality of upright members;
a plurality of roller track assemblies coupled to the frame, each roller track assembly comprising
a roller having opposing support portions;
an inner casing including a base and opposing side walls extending orthogonally from the base, one of the opposing side walls forming a notch configured to receive one of the opposing support portions of the roller, the notch of the one of the side walls defining a first interior surface; and
an outer casing having first and second walls in a parallel relationship with the opposing side walls of the inner casing, the first wall of the outer casing forming a notch configured to receive the one of the opposing support portions of the roller, the notch of the first wall of the outer casing defining a second interior surface,
wherein the outer casing is positioned with respect to the inner casing such that the one of the opposing support portions is cooperatively retained in place by a portion of the first interior surface and a portion of the second interior surface.

14. The product display of claim 13, wherein the first wall of the outer casing includes a projection extending parallel thereto, the projection partially forming an opening and further defining the second interior surface.

15. The product display of claim 14, wherein the projection is positioned to restrict movement of the one of the opposing support portions away from the inner casing.

16. The product display of claim 13, wherein the outer casing is affixed to the inner casing.

17. The product display of claim 13, wherein the outer casing is slidable with respect to the inner casing.

18. The product display of claim 13, wherein the opposing side walls of the inner casing are entirely contained within the first and second walls of the outer casing in a direction orthogonal from the base.

19. The product display of claim 13, wherein the inner casing is configured for an interference fit with the outer casing.
